(19) United States
(12) Patent Application Publication
(10) Pub. No.: US 2004/0130213 A1
(43) Pub. Date: Jul. 8, 2004

(54) Multiple outlet DC power module

(76) Inventor: Kenneth Andrew Goldsholl, Santa Barbara, CA (US)

Correspondence Address: WAGNER, MURABITO & HAO LLP, Third Floor, Two North Market Street, San Jose, CA, 95113, US

(21) Appl. No.: 10/338,403

(22) Filed: Jan. 7, 2003

(51) Int. Cl. H02J 3/00

(52) U.S. Cl. 307/11

(57) ABSTRACT

A DC power module having multiple DC outlets and an AC input. The module may be connected to a standard AC wall outlet and provides a number of DC outlets that may have different form factors and voltages. The voltage available for an outlet may be selectable. AC outlets and network adapters for coupling to the AC mains may also be provided in the module.

### FIELD OF THE INVENTION

The present claimed invention relates to the field of electric power conditioning and distribution. More particularly, the present claimed invention relates to a direct current (DC) power distribution device.

### BACKGROUND ART

Alternating current (AC) wall adapters have long been used to provide a low power source of DC power for a wide variety of electrical devices. Wall adapters plug directly into an AC outlet, and provide a regulated or unregulated DC voltage that is usually less than 24 volts. Commonly supplied voltages are 3, 6, 7.5, 9, and 12 volts.

Advances in integrated circuits have let to a proliferation of devices that rely on wall adapters for recharging of batteries and stationary use (e.g., laptop computers and music players). Additionally, the desire for improved safety has resulted in many stationary devices being provided with wall adapters in order to isolate users from the mains AC voltage.

As the utility of desktop computers has increased, the number of peripheral devices that may be used with them has also increased. Devices such as modems, scanners, cameras, speakers, and docking stations for handheld devices commonly use wall adapters for power.

The congregation of DC powered devices in the vicinity of a desktop computer often leads to a shortage of available AC outlets. Even when surge suppressors or power strips having multiple AC outlets are used to augment wall outlets, they are often inadequate due to the ability of a single wall adapter to usurp two outlets. Although a wall adapter may only require a single outlet for operation, the required insertion orientation and form factor frequently result in an unoccupied outlet being blocked from use.

The requirement for DC power by many devices has been partially addressed by techniques such as the addition of a DC power to ports or buses used for communication between devices, such as the Universal Serial Bus (USB). However, such devices provide DC power at a fixed voltage with limited current (e.g. 500 milliamperes at 5 volts).

Thus, the need exists for a source of DC power that is capable of providing adequate current to several outlets over a range of voltages. It is also desirable that the supply voltage be selectable so that a greater range and number of devices may be accommodated.

### SUMMARY OF INVENTION

The present invention provides a compact and versatile source of reliable DC power for computer peripherals and other devices. Embodiments of the present invention provide multiple DC power outlets, as well as AC power and network connections. The DC power may be provided through multiple outlets and may be provided at selectable voltages.

A DC power module having multiple DC outlets and an AC input is disclosed. The module may be connected to a standard AC wall outlet and provides a number of DC outlets that may have different form factors and voltages. The voltage available for an outlet may be selectable. AC outlets and network adapters for coupling to the AC mains may also be provided in the module.

These and other objects and advantages of the present invention will no doubt become obvious to those of ordinary skill in the art after having read the following detailed description of the preferred embodiments which are illustrated in the various drawing figures.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 shows a functional block diagram in accordance with embodiments of the present claimed invention.

FIG. 2 shows a module with an array of fixed voltage DC outlets in accordance with an embodiment of the present claimed invention.

FIG. 3 shows a module with a combination of AC outlets and fixed voltage DC outlets in accordance with an embodiment of the present claimed invention.

FIG. 4 shows a module with a combination of AC outlets and variable voltage DC outlets in accordance with an embodiment of the present claimed invention.

FIG. 5 shows a module with strain relief clamps for DC cables in accordance with an embodiment of the present claimed invention.

### DESCRIPTION OF THE PREFERRED EMBODIMENTS

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. Well known circuits and components have not been described in detail so as not to unnecessarily obscure aspects of the present invention.

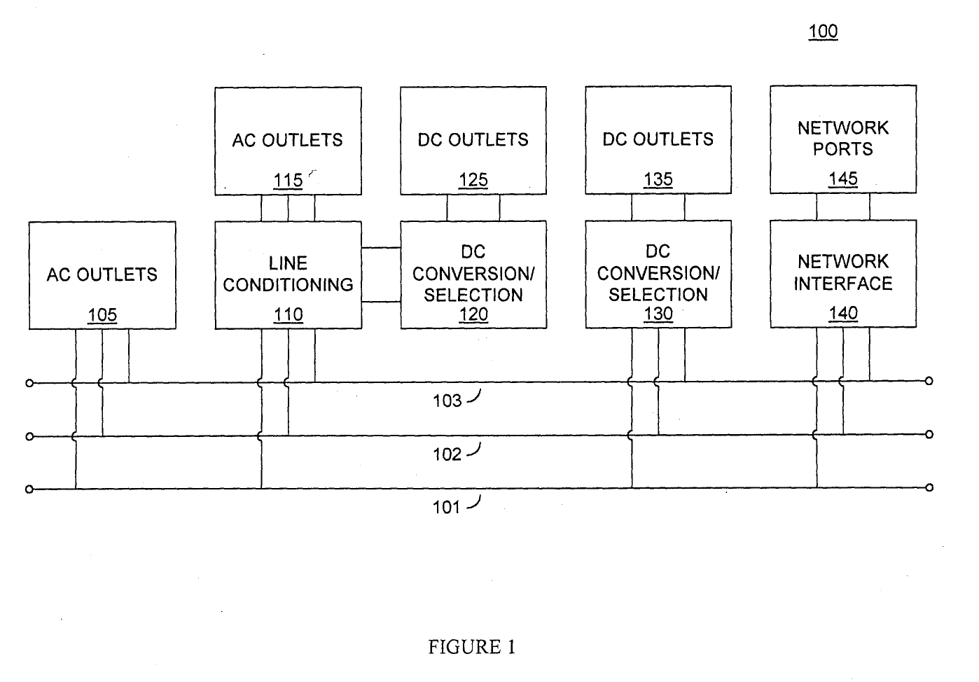

FIG. 1 shows a functional block diagram 100 for a DC power module in accordance with the present invention. Typically, connections are made between the module and mains AC power (hot 101 and neutral 102) and earth ground 103. At a minimum, the module includes DC outlets 125 or 135, and may also include one or more of the other features shown in FIG. 1.

The simplest outlet type that may be included in the module is a pass-through AC outlet 105. The pass-through outlet provides a direct connection to the mains inputs and thus serves as a simple extension AC outlet.

Conditioned AC outlets 115 may be used in preference to pass-through outlets 105. Conditioned AC outlets 115 are coupled to the mains inputs by line conditioning circuits 110. The line conditioning circuits may provide noise filtering, transient suppression, and overcurrent protection.

A first type of DC outlet 125 is coupled to the line conditioning circuits 110 by DC conversion/selection circuits 120. This configuration is preferred in modules that include both AC and DC outlets. Coupling the DC conversion/selection circuits to the line conditioning circuits 110 provides an additional degree of integrity for the DC power.

A second type of DC outlet 135 is coupled to the mains by DC conversion/selection circuits 130. This configuration may be used in modules that do not provide AC outlets. The line conditioning circuits 110 may be combined whole or in part with DC conversion/selection circuits 120 to provide DC conversion/selection circuits 130.

The DC selection function provided may be performed by a switch that allows a user to select from two or more available voltages, or it may be provided by a microcontroller that sets the output voltage on the basis of the current/voltage characteristics of the load.

For attached devices having nonlinear I-V characteristics, a microcontroller may be used to sense the connection of a load, and subsequently ramp the supplied DC voltage while observing the current versus voltage relationship. An example of a criterion used to set the DC voltage is the rate of change of current with respect to the supplied voltage (e.g., the slope of the I-V characteristic).

Alternatively, the DC conversion/selection circuit may communicate with the attached device through the DC power cable upon connection and establish the output voltage through an initial “handshake.” The handshake between an attached device may include the maximum allowable current for the device, in addition to the required voltage.

The DC outlet may incorporate a switch that senses the insertion of a plug and subsequently connects the DC conversion/selection circuit (120,130) to the AC power. By allowing the DC circuits to be disconnected when not required, the overall efficiency and reliability is improved.

AC wiring such as that found in typical residence may be used for networking. In the present invention, network ports 145 (e.g., RJ-45) may be supplied. The Network ports may be coupled to the AC mains by a network interface circuit 140 that provides isolation and filtering.

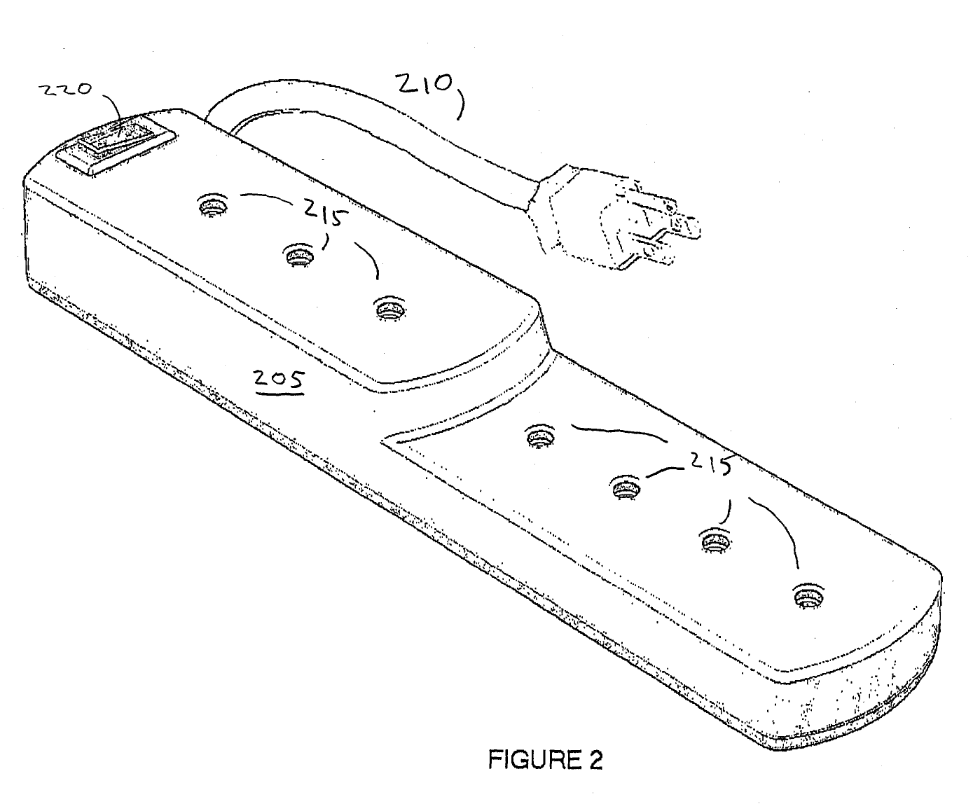

FIG. 2 shows a fixed voltage module 205 with an array of fixed voltage DC outlets 215. The individual outlets in the array may have the same voltage, or more than one voltage may be supplied by the array. Likewise, the physical form factor for each outlet may be uniform, or they may be different. The form factor for each outlet may also correspond to a particular voltage.

The individual DC outlet is, in one embodiment, a socket that accepts a coaxial plug having two poles, with one pole associated with a center conductor and the other pole associated with an outer conductor. A coaxial outlet is defined as an outlet that accepts a coaxial plug. When multiple fixed voltages are supplied, a larger diameter plug may be used for lower voltage outlets as compared to the higher voltage outlets. This prevents a lower voltage plug from being inserted into a higher voltage outlet. The voltage of an output is the voltage provided between the two poles.

The module 205 may include an AC power cord 210 that may be either fixed, or removable from the module 205. A power switch 220 may also be included in the module. The power switch may in turn include one or more status lamps that indicate whether or not the AC power is switched on, or whether a fault has been sensed in an attached load (e.g., overcurrent condition or short circuit).

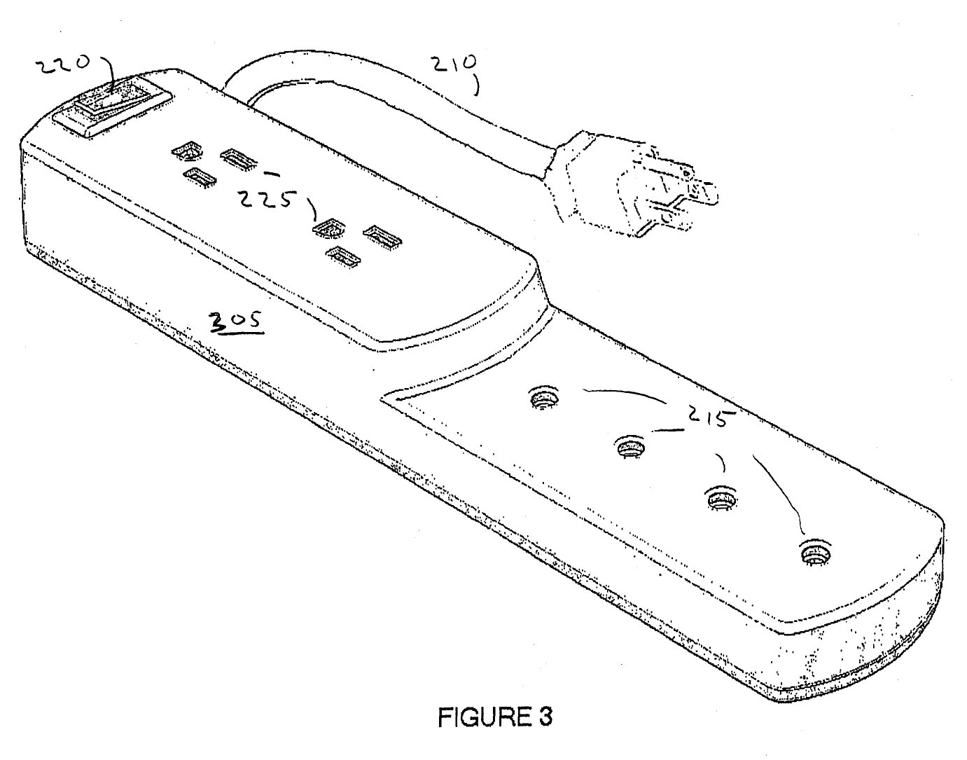

FIG. 3 shows a module 305 with a combination of AC outlets 225 and fixed voltage DC outlets 215. The AC outlets may be switched or unswitched, and may or may not be coupled to the AC mains by line conditioning circuits.

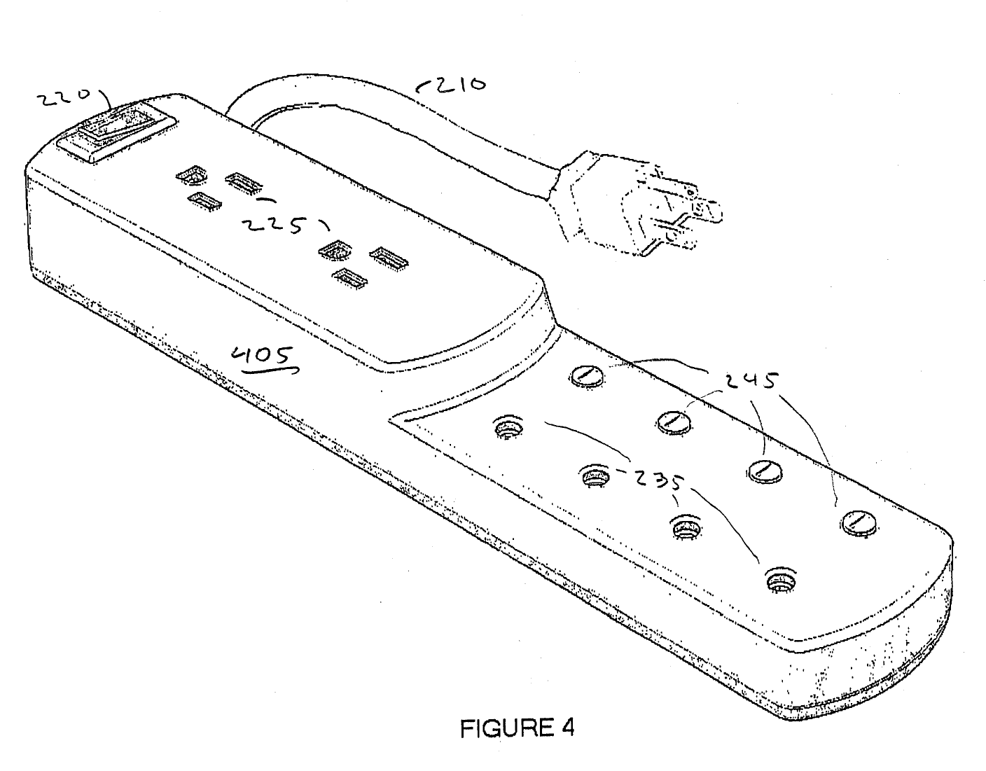

FIG. 4 shows a module 405 with a combination of AC outlets 225 and variable voltage DC outlets 235. Each of the DC outlets 235 has a corresponding voltage selection switch 245 that is used to select from two or more supplied voltages.

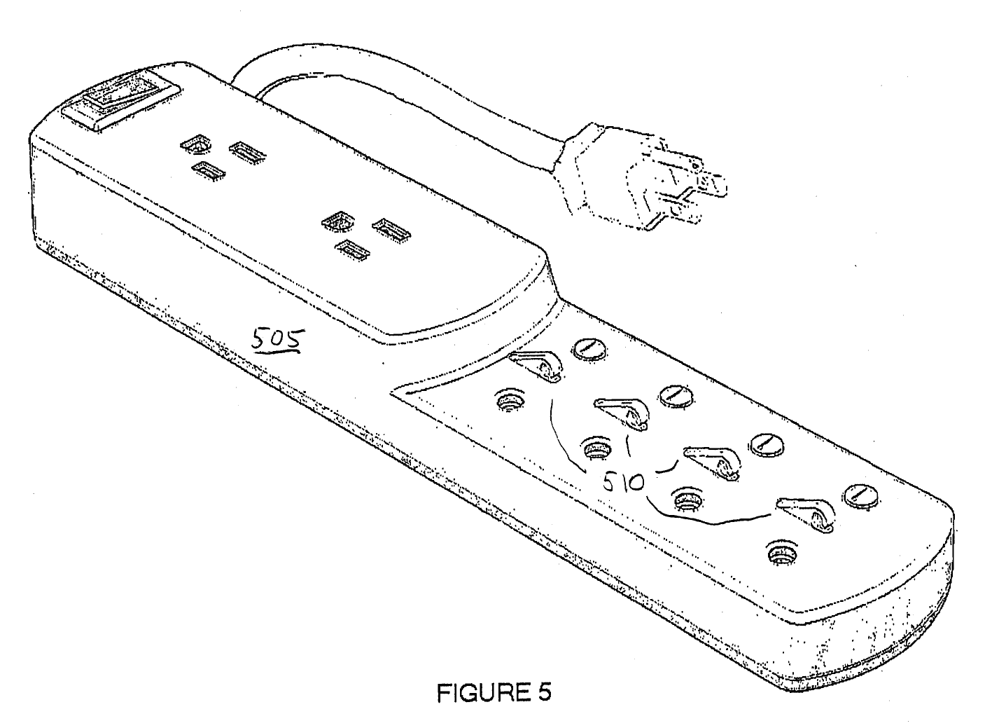

FIG. 5 shows a module 505 similar to module 405, but with additional strain relief clamps 510. The strain relief clamps may be used to secure DC cables and reduce the stress that is applied to the cable plug.

1. A multiple outlet direct current (DC) power module comprising:
an alternating current (AC) power cord; and
a plurality of DC outlets.

2. The module of claim 1, further comprising at least one AC outlet.

3. The module of claim 1, further comprising a selection switch for selecting an output voltage for at least one of the DC outlets.

4. The module of claim 1, comprising a first outlet with a first physical form factor, and a second outlet with a second physical form factor that is different from said first physical form factor.

5. The module of claim 4, wherein said first form factor corresponds to a first output voltage, and said second physical form factor corresponds to a second output voltage that is different from said first output voltage.

6. The module of claim 1, wherein said power cord is removable from said module.

7. The module of claim 1 wherein said power cord is fixed to said module.

8. The module of claim 1, further comprising a network port.

9. A multiple outlet DC power module comprising:
AC power inputs; and
a plurality of DC outlets coupled to said alternating power inputs by a DC conversion/selection circuit.

10. The module of claim 9, further comprising at least one AC outlet.

11. The module of claim 10, wherein said AC outlet is coupled to said AC power inputs by a line conditioning circuit.

12. The module of claim 11, wherein said DC conversion/selection circuit is coupled to said line conditioning circuit.

13. The module of claim 9, further comprising at least one network port coupled to said AC power inputs.

14. The module of claim 13, wherein said network port is coupled to said AC power inputs by a network interface.

15. The module of claim 9, wherein said DC conversion/selection circuit comprises a switch for selecting an output voltage for at least on of the DC outlets.

16. The module of claim 9, wherein said DC conversion/selection circuit comprises a microcontroller for adjusting an output voltage of at least one of the DC outlets.

17. A method for providing DC power from an AC input comprising:
providing AC inputs and a plurality of coaxial DC outlets in a single housing; and
coupling said AC inputs to said DC outlets with a DC conversion/selection circuit.

18. The method of claim 17, further comprising providing a network port coupled to said AC inputs.

19. The method of claim 17, further comprising providing a microcontroller for adjusting the voltage of at least one of said DC outputs.

20. The method of claim 17, further comprising providing at least one AC output coupled to said AC inputs.
